(19) United States
(12) Patent Application Publication
(10) Pub. No.: US 2024/0214401 A1
(43) Pub. Date: Jun. 27, 2024

(54) IN-VEHICLE RELAY DEVICE, RELAY METHOD, AND RELAY PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Shogo KAMIGUCHI, Yokkaichi-shi, Mie (JP)

(21) Appl. No.: 18/557,378

(22) PCT Filed: Mar. 25, 2022
(86) PCT No.: PCT/JP2022/014247

§ 371 Date: Oct. 26, 2023

(30) Foreign Application Priority Data
Apr. 28, 2021 (JP) 2021-076437

(51) Int. Cl. H04L 9/40; B60R 16/023; H04L 12/44

(52) U.S. Cl. CPC H04L 63/1416; B60R 16/0231; H04L 12/44

(57) ABSTRACT

Provided is an in-vehicle relay device including a relay unit that relays frames transmitted and received between one in-vehicle device and another in-vehicle device in an in-vehicle network, a calculation unit that calculates a processing load of the other in-vehicle device based on frames that were received from the in-vehicle device by the relay unit and are addressed to the other in-vehicle device, and a determination unit that determines whether or not the relay unit is to relay the frames addressed to the other in-vehicle device based on the processing load calculated by the calculation unit.

### CROSS-REFERENCE TO RELATED APPLICATIONS

This application is the U.S. national stage of PCT/JP2022/014247 filed on Mar. 25, 2022, which claims priority of Japanese Patent Application No. JP 2021-076437 filed on Apr. 28, 2021, the contents of which are incorporated herein.

### TECHNICAL FIELD

The present disclosure relates to an in-vehicle relay device, a relay method, and a relay program.

### BACKGROUND

JP 2008-252221A discloses the following device. That is, disclosed is a DOS attack defense device that monitors packets transmitted and received between a communication terminal and a server connected to the communication terminal via a network, and includes: a packet receiving means that receives a packet; and a packet transmitting means that determines whether or not the received packet is transmittable, based on the received packet, and transmits the received packet if the received packet is transmittable. In this device, the packet rate, that is to say the number of packets per unit time, is measured, and packets are discarded when a pre-set threshold is exceeded.

Further, JP 2019-523584A discloses the following method. That is, disclosed is a network attack defense method including: a step of obtaining a set of one or more statistical attributes for a protected site by collecting statistical values regarding the set of one or more statistical attributes for the protected site, the set of one or more statistical attributes for the protected site indicating a mode of operation of the protected site; a step of determining that the protected site is to transition from a current operation mode to a target operation mode at least partially based on the set of one or more statistical attributes, the current operation mode having a current defensive strategy, the target operation mode having a target defensive strategy, and the current defensive strategy being different from the target defensive strategy; and a step of transitioning from the current operation mode to the target operation mode in accordance with the determination that the protected site is to transition from the current operation mode to the target operation mode, and applying the target defensive strategy to the protected site.

Conventionally, techniques have been developed to improve security in in-vehicle networks.

In an in-vehicle network, the volume of packets transmitted in an in-vehicle network changes depending on the driving pattern, the functions that are used, and the like. In order to obtain statistical quantities regarding packets transmitted in the in-vehicle network, it is necessary to try various situations with different driving patterns and with and without the usage of functions.

The present disclosure has been achieved to solve the aforementioned problem, and an object thereof is to provide an in-vehicle relay device, a relay method, and a relay program that can easily improve security in an in-vehicle network.

### SUMMARY

An in-vehicle relay device of the present disclosure includes a relay unit configured to relay frames transmitted and received between one in-vehicle device and another in-vehicle device in an in-vehicle network; a calculation unit configured to calculate a processing load of the other in-vehicle device based on a plurality of frames that were received from the one in-vehicle device by the relay unit and are addressed to the other in-vehicle device; and a determination unit configured to determine whether or not the relay unit is to relay the frames addressed to the other in-vehicle device based on the processing load calculated by the calculation unit.

A relay method of the present disclosure is a relay method in an in-vehicle relay device having a relay unit that relays a plurality of frames transmitted and received between one in-vehicle device and another in-vehicle device in an in-vehicle network, the method including the steps of calculating a processing load of the other in-vehicle device based on a plurality of frames that were received from the one in-vehicle device by the relay unit and are addressed to the other in-vehicle device; and determining whether or not the relay unit is to relay the frames addressed to the other in-vehicle device based on the calculated processing load.

A relay program of the present disclosure is a relay program to be used in an in-vehicle relay device and causing a computer to function as: a relay unit configured to relay frames transmitted and received between one in-vehicle device and another in-vehicle device in an in-vehicle network; a calculation unit configured to calculate a processing load of the other in-vehicle device based on a plurality of frames that were received from the one in-vehicle device by the relay unit and are addressed to the other in-vehicle device; and a determination unit configured to determine whether or not the relay unit is to relay the frames addressed to the other in-vehicle device based on the processing load calculated by the calculation unit.

An aspect of the present disclosure can be implemented not only as an in-vehicle relay device including such a characteristic processing unit, but also as a semiconductor integrated circuit that implements part or all of the in-vehicle relay device or as a system including the in-vehicle relay device.

### Advantageous Effects

The present disclosure can easily improve security in an in-vehicle network.

### BRIEF DESCRIPTION OF DRAWINGS

FIG. 1 is a diagram showing a configuration of an in-vehicle system according to an embodiment of the present disclosure.

FIG. 2 is a diagram showing a configuration of an in-vehicle relay device in the in-vehicle system according to an embodiment of the present disclosure.

FIG. 3 is a diagram showing an example of frame processing information in the in-vehicle relay device according to the embodiment of the present disclosure.

FIG. 4 is a diagram showing an example of load information in the in-vehicle relay device according to the embodiment of the present disclosure.

FIG. 5 is a diagram showing an example of load information in the in-vehicle relay device according to the embodiment of the present disclosure.

FIG. 6 is a diagram showing an example of frame restriction processing performed by the in-vehicle relay device according to the embodiment of the present disclosure.

FIG. 7 is a flowchart defining an example of an operation procedure when the in-vehicle relay device according to the embodiment of the present disclosure received frames.

FIG. 8 is a flowchart defining an example of the operation procedure when the in-vehicle relay device according to the embodiment of the present disclosure updates the load information.

### DETAILED DESCRIPTION OF PREFERRED EMBODIMENTS

First, embodiments of the present disclosure will be listed and described.

An in-vehicle relay device according to an embodiment of the present disclosure includes: relay unit configured to relay frames transmitted and received between one in-vehicle device and another in-vehicle device in an in-vehicle network; a calculation unit configured to calculate a processing load of the other in-vehicle device based on a plurality of frames that were received from the one in-vehicle device by the relay unit and are addressed to the other in-vehicle device; and a determination unit configured to determine whether or not the relay unit is to relay the frames addressed to the other in-vehicle device based on the processing load calculated by the calculation unit.

In this way, the processing load of an in-vehicle device is calculated based on the frames that were received by the relay device and are addressed to the same in-vehicle device, and whether or not frames addressed to the in-vehicle device are to be relayed is determined using the calculation results, and therefore, in an in-vehicle network in which, for example, the volume of packets transmitted in the in-vehicle network varies depending on the driving patterns, the functions that are used, and the like, it is possible to defend against an attack performed using the transmission of frames to an in-vehicle device, without trying various situations with different driving patterns and with and without functions. Accordingly, security in the in-vehicle network can be easily improved.

The in-vehicle relay device may further include a storage unit configured to store frame processing information indicating a processing load of frames in each of the in-vehicle devices for each type of frame, and the calculation unit may calculate the processing load based on the type of each of the received frames and the frame processing information.

When a device processes received packets, the processing load varies depending on the type of the packets. For example, in the case where an attack involving transmitting a small number of packets requiring a high processing load is made against a specific in-vehicle device, it is possible to defend against such an attack more reliably with the aforementioned configuration in which the determination is made in consideration of differences in processing load according to the type of packets, as compared with a configuration in which the determination is made by simply using communication traffic such as the number of packets per unit time as a criterion.

The frame processing information may further indicate the processing time required for each of the in-vehicle devices to process frames for each type of frame, and the calculation unit may update the processing load based on an elapsed time from when the relay unit received or relayed the received frames and the processing time corresponding to the received frames.

Such a configuration enables an appropriate determination to be made further in consideration of differences in processing completion time depending on the type of packet.

The in-vehicle relay device may further include a storage unit configured to store frame processing information indicating, for each of the in-vehicle devices, a processing load of frames in the in-vehicle device, and the calculation unit may calculate the processing load based on the processing load corresponding to the other in-vehicle device in the frame processing information.

When an in-vehicle device processes received packets, the processing load varies depending on the specifications or the like of the in-vehicle device. The aforementioned configuration enables an appropriate determination to be made in consideration of differences in processing load according to the specifications of the in-vehicle device, as compared with a configuration in which the determination is made by simply using communication traffic such as the number of packets per unit time as a criterion.

The frame processing information may further indicate, for each of the in-vehicle devices, a processing time required for the in-vehicle device to process frames, and the calculation unit may update the processing load based on an elapsed time from when the relay unit received or relayed the received frames and the processing time corresponding to the received frames.

Such a configuration enables an appropriate determination to be made further in consideration of differences in processing completion time according to specifications or the like of the in-vehicle device.

The in-vehicle relay device may further include a storage unit configured to store frame processing information indicating a threshold of the processing load for each of the in-vehicle devices, and the determination unit may make the determination based on a comparison result of a comparison between the processing load calculated by the calculation unit and the threshold corresponding to the other in-vehicle device in the frame processing information.

The processing load that is permitted in an in-vehicle device varies depending on the specifications or the like of the in-vehicle device. The aforementioned configuration enables an appropriate determination to be made in consideration of differences in the allowable processing load according to the specifications or the like of the in-vehicle device.

The determination unit may make the determination based on a comparison result of a comparison between the processing load calculated by the calculation unit and a threshold, and the threshold may be a value based on a result of measurement of a frame transmission cycle in a vehicle having a predetermined network configuration.

Such a configuration enables, for example, best-effort communication to be performed and a more appropriate threshold to be set in an in-vehicle network where the used bandwidth varies according to the situation of the vehicle.

The in-vehicle relay device may relay the frames transmitted and received between the in-vehicle devices in a star topology with peer-to-peer communication.

In this way, it is possible to easily restrict transmission of frames transmitted and received between in-vehicle devices by the configuration in which the in-vehicle relay device relays frames in a star topology with peer-to-peer communication, for example, as compared with a configuration having a CAN (Controller Area Network) bus.

The relay method according to an embodiment of the present disclosure is a relay method in an in-vehicle relay device including a relay unit that relays frames transmitted and received between one in-vehicle device and another in-vehicle device in an in-vehicle network, the method comprising the steps of calculating a processing load of the other in-vehicle device based on a plurality of frames that were received from the one in-vehicle device by the relay unit and are addressed to the other in-vehicle device; and determining whether or not the relay unit is to relay the frames addressed to the other in-vehicle device based on the calculated processing load.

In this way, the processing load of an in-vehicle device is calculated based on the frames that were received by the relay device and are addressed to the same in-vehicle device, and whether or not frames addressed to the in-vehicle device are to be relayed is determined using the calculation results, and therefore, in an in-vehicle network in which, for example, the volume of packets transmitted in the in-vehicle network varies depending on the driving patterns, the functions that are used, and the like, it is possible to defend against an attack performed using the transmission of frames to an in-vehicle device, without trying various situations with different driving patterns and with and without functions. Accordingly, security in the in-vehicle network can be easily improved.

The relay program according to an embodiment of the present disclosure is a relay program to be used in an in-vehicle relay device and causing a computer to function as: a relay unit configured to relay frames transmitted and received between one in-vehicle device and another in-vehicle device in an in-vehicle network; a calculation unit configured to calculate a processing load of the other in-vehicle device based on a plurality of frames that were received from the one in-vehicle device by the relay unit and are addressed to the other in-vehicle device; and a determination unit configured to determine whether or not the relay unit is to relay the frames addressed to the other in-vehicle device based on the processing load calculated by the calculation unit.

In this way, the processing load of an in-vehicle device is calculated based on the frames that were received by the relay device and are addressed to the same in-vehicle device, and whether or not frames addressed to the in-vehicle device are to be relayed is determined using the calculation results, and therefore, in an in-vehicle network in which, for example, the volume of packets transmitted in the in-vehicle network varies depending on the driving patterns, the functions that are used, and the like, it is possible to defend against an attack performed using the transmission of frames to an in-vehicle device, without trying various situations with different driving patterns and with and without functions. Accordingly, security in the in-vehicle network can be easily improved.

Hereinafter, embodiments of the present disclosure will be described with reference to drawings. In the drawings, the same or corresponding portions are denoted by the same reference numerals, and descriptions thereof are not repeated. Further, at least portions of the embodiments described below may be optionally combined.

### Configuration and Basic Operation

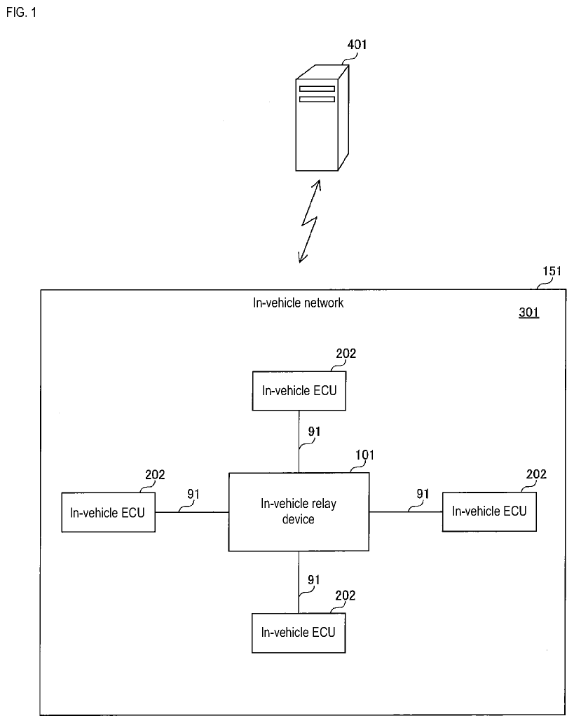

FIG. 1 is a diagram showing the configuration of an in-vehicle system according to an embodiment of the present disclosure. As shown in FIG. 1, an in-vehicle system 301 is mounted in a vehicle and includes an in-vehicle relay device 101 and a plurality of in-vehicle devices 202.

The in-vehicle system 301 may be configured to include a plurality of in-vehicle relay devices 101. FIG. 1 shows the case where the in-vehicle system 301 includes one in-vehicle relay device 101 and four in-vehicle ECUs (Electronic Control Units) 202 as an example.

The in-vehicle ECUs 202 are one example of in-vehicle devices, and examples thereof include TCUs (Telematics Control Units), autonomous driving ECUs, engine ECUs, sensors, navigation devices, human-machine interfaces, and cameras. TCUs communicate with devices outside vehicles, such as a server 401 and wireless base stations or the like, which are not shown. The in-vehicle devices may be devices brought into vehicles by the user, and examples thereof include mobile terminals such as tablets, or electronic devices such as USB (Universal Serial Bus) memories.

The in-vehicle relay device 101 and the in-vehicle ECUs 202 constitute an in-vehicle network 151. The in-vehicle ECUs 202 and the in-vehicle relay device 101 are examples of in-vehicle devices in the in-vehicle network 151. The types of in-vehicle devices in the in-vehicle network 151, and the network configuration, including the connection relationship and the communication protocol, are fixed. New in-vehicle devices, electronic devices, or the like may be added to the in-vehicle network 151.

The in-vehicle relay device 101 can relay information between the in-vehicle ECUs 202 in the in-vehicle network 151. More specifically, the in-vehicle relay device 101 can perform relay processing in accordance with Layer 2, which is an OSI (Open Systems Interconnection) reference model, for example. The in-vehicle relay device 101 may be configured to perform relay processing in accordance with Layer 3, which is higher than Layer 2, in addition to Layer 2.

In the in-vehicle network 151, the in-vehicle ECUs 202 are connected to the in-vehicle relay device 101, via Ethernet (registered trademark) cables 91, for example.

The in-vehicle relay device 101 relays Ethernet frames in accordance with the Ethernet communication standard. Specifically, the in-vehicle relay device 101 relays Ethernet frames exchanged between the in-vehicle ECUs 202, for example. IP packets are stored in Ethernet frames.

The in-vehicle system 301 is not limited to relaying Ethernet frames in accordance with the Ethernet communication standard, and may be configured to relay data in accordance with communication standards such as CAN (Controller Area Network) (R), CAN-FD (CAN with Flexible Data Rate), FlexRay (R), MOST (Media Oriented Systems Transport) (R), and LIN (Local Interconnect Network).

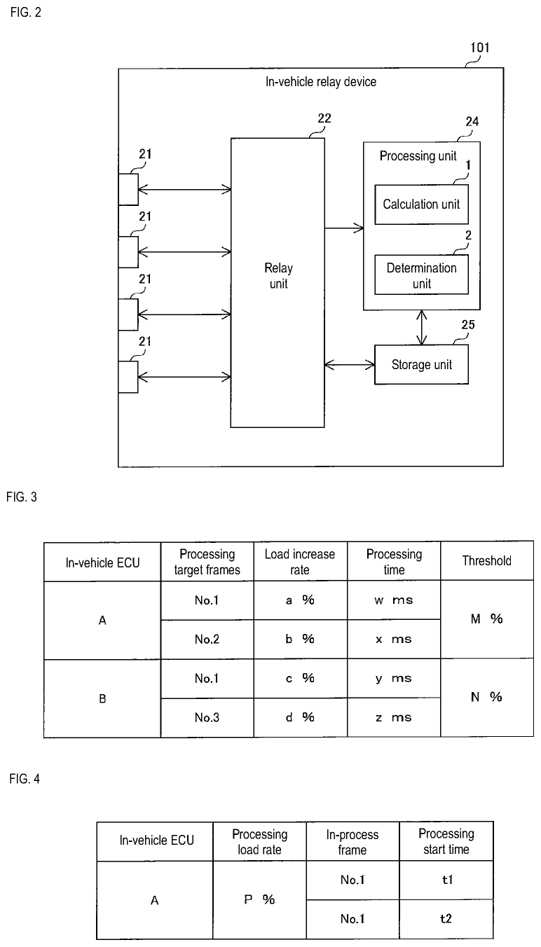

FIG. 2 is a diagram showing the configuration of the in-vehicle relay device in the in-vehicle system according to the embodiment of the present disclosure. As shown in FIG. 2, the in-vehicle relay device 101 includes four communication ports 21, a relay unit 22, a processing unit 24, and a storage unit 25. The processing unit 24 includes a calculation unit 1 and a determination unit 2. The in-vehicle relay device 101 is not limited to having a configuration including four communication ports 21, and may be configured to include two, three, or five or more communication ports 21.

The communication ports 21 are each a terminal to which an Ethernet cable 91 can be connected, for example. The communication port 21 may be a terminal of an integrated circuit. The four communication ports 21 are connected to the in-vehicle ECUs 202 respectively via the Ethernet cables 91.

The processing unit 24 is implemented by processors such as CPUs (Central Processing Units) and DSPs (Digital Signal Processors). The relay unit 22 is implemented, for example, by an L2 switch IC and a processor. The storage unit 25 is a non-volatile memory, for example.

The relay unit 22 relays frames transmitted and received between the in-vehicle ECUs 202 in the in-vehicle network 151. For example, the relay unit 22 can function as an L2 switch, and relays Ethernet frames transmitted between the in-vehicle ECUs 202 connected to the corresponding in-vehicle relay device 101. More specifically, upon receiving Ethernet frames from an in-vehicle ECU 202 via the corresponding Ethernet cable 91, the relay unit 22 transmits the received Ethernet frames to an in-vehicle ECU 202 as a destination via the corresponding Ethernet cable 91. The relay unit 22 can function as an L3 switch and may be configured to relay Ethernet frames transmitted between in-vehicle ECUs 202 connected to a different in-vehicle relay device 101.

The relay unit 22 performs the relay processing described above by, for example, referring to a table showing the correspondence between destination MAC addresses and the communication ports 21, which is stored in the storage unit 25.

The calculation unit 1 calculates the processing load of another in-vehicle ECU 202 (which will be hereinafter referred to as a destination ECU) based on a plurality of frames that were received from the in-vehicle ECU 202 by the relay unit 22 and are addressed to the other in-vehicle ECU 202, that is, calculates an estimated value of the processing load in the in-vehicle ECU 202.

The determination unit 2 determines whether or not the relay unit 22 is to relay the frames addressed to the other in-vehicle ECU 202 based on the processing load calculated by the calculation unit 1.

FIG. 3 is a table showing an example of frame processing information in the in-vehicle relay device according to the embodiment of the present disclosure.

The storage unit 25 stores frame processing information indicating the processing load of the frames in the in-vehicle ECU 202, for each in-vehicle ECU 202 and each type of frame. The frame processing information further indicates the processing time required for processing the frames in the in-vehicle ECU 202, for each in-vehicle ECU 202 and each type of frame, for example.

Further, the storage unit 25 stores frame processing information indicating a processing load threshold for each in-vehicle ECU 202.

Specifically, as shown in FIG. 3, the frame processing information is information indicating a correspondence between an in-vehicle ECU, a processing target frame, a load increase rate, a processing time, and a processing load rate threshold.

For example, when an in-vehicle ECU-A processes frames No. 1 as the processing target frames, the processing load rate of the processor increases by a %, and the processing time required to complete the processing of the frames is w milliseconds, and when processing frames No. 2 as the processing target frames, the processing load rate of the processor increases by b %, and the processing time required to complete the processing of the frames is x milliseconds. When an in-vehicle ECU-B processes frames No. 1 as the processing target frames, the processing load rate of the processor increases by c %, and the processing time required to complete the processing of the frames is y milliseconds, and when processing frames No. 3 as the processing target frames, the processing load rate of the processor increases by d %, and the processing time required to complete the processing of the frames is z milliseconds.

Further, the determination unit 2 determines to stop relaying the Ethernet frames addressed to the in-vehicle ECU-A when the processing load rate of the processor of the in-vehicle ECU-A exceeds M % and determines to stop relaying the Ethernet frames addressed to the in-vehicle ECU-B when the processing load rate of the processor of the in-vehicle ECU-B exceeds N %.

FIGS. 4 and 5 are tables showing examples of the load information in the in-vehicle relay device according to the embodiment of the present disclosure.

As shown in FIGS. 4 and 5, the storage unit 25 stores load information indicating a correspondence between an estimated value of the current processing load rate, an in-process frame, and a processing start time of frame processing for each in-vehicle ECU 202.

For example, in the example shown in FIG. 4, the in-vehicle ECU-A processes two frames No. 1, the processing start times for these two frames are respectively t1 and t2, and the estimated value of the current processing load rate is P %. Here, the processing start time is, for example, the time at which the in-vehicle relay device 101 receives the frame or the time at which it transmit the frame to the destination in-vehicle ECU 202.

The relay unit 22 receives the Ethernet frames and notifies the processing unit 24 of information such as the destination MAC address and the logical port number of the received Ethernet frames.

The processing unit 24 determines the destination, the type, and the like of the Ethernet frames using information notified by the relay unit 22.

In the case where relay “permission” for the Ethernet frames is notified by the processing unit 24 after notification of the information, the relay unit 22 relays the Ethernet frames to the destination in-vehicle ECU 202, whereas in the case where relay “prohibition” is notified, the relay unit 22 discards the Ethernet frames without relaying them.

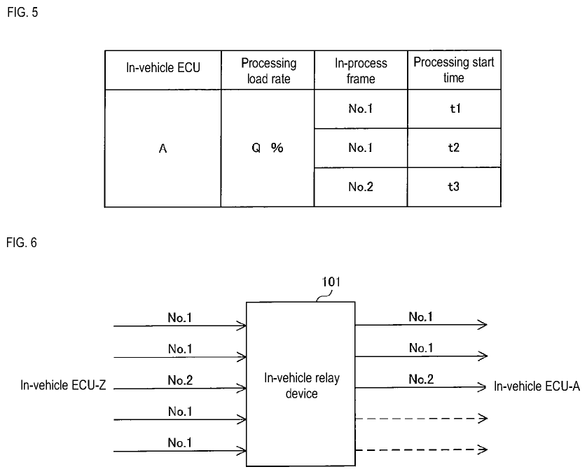

FIG. 6 is a diagram showing an example of frame restriction processing performed by the in-vehicle relay device according to the embodiment of the present disclosure.

The calculation unit 1 calculates the total of load increase rates respectively corresponding to a plurality of frames, as a processing load of another in-vehicle ECU 202.

For example, the calculation unit 1 calculates the processing load rate of the other in-vehicle ECU 202 based on the frames that were received by the relay unit 22 from an in-vehicle ECU 202 and are addressed to the other in-vehicle ECU 202, and also based on the processing load corresponding to the other in-vehicle ECU 202 in the frame processing information, that is to say the load increase rate.

Further, for example, the calculation unit 1 calculates the processing load rate of the other in-vehicle ECU 202 based on the types of the frames and the frame processing information.

The determination unit 2 makes a determination based on the comparison results between the processing load rate calculated by the calculation unit 1 and the threshold corresponding to the other in-vehicle ECU 202 in the frame processing information.

Specifically, with reference to FIG. 6, the following describes the case where a large amount of frames are streamed in order to exhaust the resource of the in-vehicle ECU-A that is an in-vehicle ECU 202 via an in-vehicle ECU-Z that is an in-vehicle ECU 202.

First, the frames No. 1 addressed to the in-vehicle ECU-A are transmitted from the in-vehicle ECU-Z to the in-vehicle relay device 101. The calculation unit 1 adds a % to the processing load rate of the in-vehicle ECU-A. The determination unit 2 registers the sum processing load rate and the processing start time t1 of the frames No. 1 in load information and notifies the relay unit 22 of relay “permission” for the frames, since the sum processing load rate obtained by the calculation unit 1 does not exceed M %.

Then, the frames No. 1 addressed to the in-vehicle ECU-A are transmitted from the in-vehicle ECU-Z to the in-vehicle relay device 101. The calculation unit 1 adds a % to the processing load rate of the in-vehicle ECU-A. The processing load rate is P %, which is smaller than M %. Since the sum processing load rate obtained by the calculation unit 1 does not exceed M %, the determination unit 2 registers the sum processing load rate and the processing start time t2 of the frames No. 1 in load information and notifies the relay unit 22 of relay “permission” for the frames. FIG. 4 shows this state.

Then, the frames No. 2 addressed to the in-vehicle ECU-A are transmitted from the in-vehicle ECU-Z to the in-vehicle relay device 101. The calculation unit 1 adds b % to the processing load rate of the in-vehicle ECU-A. The processing load rate is Q %, which is smaller than M %. Since the sum processing load rate obtained by the calculation unit 1 does not exceed M %, the determination unit 2 registers the sum processing load rate and a processing start time t3 of the frames No. 2 in load information and notifies the relay unit 22 of relay “permission” for the frames. FIG. 5 shows this state.

Then, the frames No. 1 addressed to the in-vehicle ECU-A are transmitted from the in-vehicle ECU-Z to the in-vehicle relay device 101. The calculation unit 1 adds a % to the processing load rate of the in-vehicle ECU-A. The processing load rate is R %, which is larger than M %. Since the sum processing load rate obtained by the calculation unit 1 exceeds M %, the determination unit 2 notifies the relay unit 22 of “prohibition” for the relay of the frames. The load information remains in the state shown in FIG. 5, for example.

Thereafter, the determination unit 2 prohibits the relay of frames, and the relay unit 22 discards the received frames addressed to the in-vehicle ECU-A, until the processing load rate decreases and the sum of the processing load rate and the load increase rate corresponding to the frames newly received becomes M % or less. Thereby, it is possible to defend against an attack of streaming a large amount of frames from the in-vehicle ECU-Z to the in-vehicle ECU-A.

For example, the threshold to be used by the determination unit 2 for the comparison with the processing load calculated by the calculation unit 1 may be a value that is based on the measurement results of the frame transmission cycle in a vehicle having a predetermined network configuration.

Specifically, for example, a log of measurement results in a certain vehicle is analyzed to calculate the communication cycle for each destination in-vehicle ECU 202 and each type of frame, and the variance of the communication cycle from the design value is calculated. In the case where the variance is large, the threshold is set lower, whereas in the case where the variance is small, the threshold is set higher. The log is, for example, a log obtained in another vehicle having the same vehicle type, model number, or the like.

### Operation Flow

Each device in the in-vehicle system of the embodiment of the present disclosure includes a computer including a memory, and an arithmetic processor such as a CPU (Central Processing Unit) in the computer reads a program that includes some or all of the steps of the following flowchart from the memory and executes it. The programs of the devices can be installed from the outside. The programs of the devices are stored in recording media and distributed in that form.

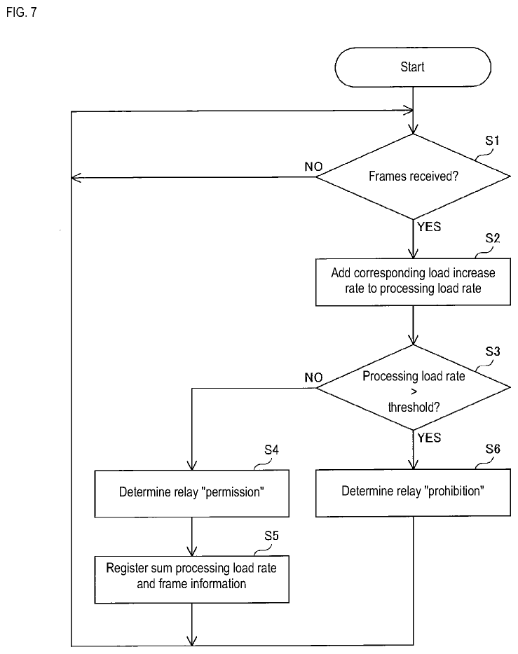

FIG. 7 is a flowchart defining an example of an operation procedure when the in-vehicle relay device according to the embodiment of the present disclosure received frames.

As shown in FIG. 7, the in-vehicle relay device 101 first waits for frames addressed to a destination in-vehicle ECU 202 (which will be hereinafter referred to as a destination ECU) to be received from an in-vehicle ECU 202 (NO in step S1), and upon receiving such frames (YES in step S1), refers to frame processing information and adds the load increase rate corresponding to the frames to the processing load rate of the destination ECU (in step S2).

Then, the in-vehicle relay device 101 determines relay permission of the frames in the case where the sum processing load rate does not exceed the threshold corresponding to the destination ECU (NO in step S3) (in step S4), and registers the sum processing load rate and information of the frames in the load information. The in-vehicle relay device 101 relays the frames to the destination ECU (in step S5).

However, in the case where the sum processing load rate exceeds the threshold corresponding to the destination ECU (YES in step S3), the in-vehicle relay device 101 determines prohibition of the relay of the frames, and does not update the load information. The in-vehicle relay device 101 discards the frames (in step S6).

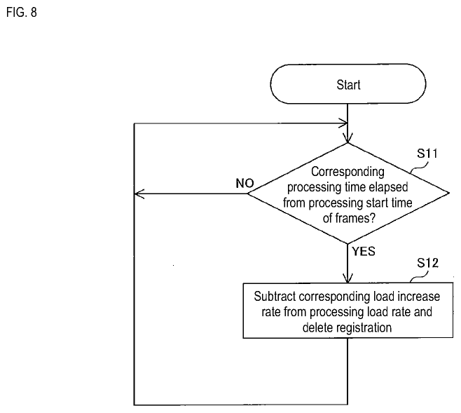

FIG. 8 is a flowchart defining an example of an operation procedure when the in-vehicle relay device according to the embodiment of the present disclosure updates the load information.

For example, the calculation unit 1 updates the processing load of the destination ECU based on the elapsed time from when the relay unit 22 receives or relays the frames, and the processing time corresponding to the frames.

More specifically, the calculation unit 1 monitors the elapsed time from the processing start time of the frames and, when the corresponding processing time has elapsed from the processing start time of the frames, subtracts the corresponding load increase rate from the processing load rate in the load information, to delete the information of the frames from the load information.

Specifically, as shown in FIG. 8, the in-vehicle relay device 101 first waits for the elapse of the processing time corresponding to the frames from the processing start time of the relayed frames (NO in step S11).

Then, when the corresponding processing time has elapsed from the processing start time of the relayed frames (YES in step S11), the calculation unit 1 in the in-vehicle relay device 101 refers to the frame processing information in the load information and subtracts the load increase rate corresponding to the frames from the processing load rate of the destination ECU, to delete the information of the frames from the load information (in step S12), and waits for the elapse of the corresponding processing time from the processing start time of other relayed frames (NO in step S11).

As described above, by not only using the processing load of the most recently received frames, but also using the cumulative value of the processing load of previously received frames, the processing load of an in-vehicle ECU 202 can be accurately predicted by calculating the processing load of the in-vehicle ECU 202 when it is assumed that the destination in-vehicle ECU 202 processes the most recently received frames before relaying.

Further, even in a state where frame relaying is stopped, it is possible to appropriately determine whether to restart relaying by continuing to update the processing load rate in consideration of the completion of the processing of previously relayed frames. Further, it is also possible to appropriately determine whether to stop relaying again after restarting relaying.

As described above, the type of each in-vehicle device and the network configuration, including the connection relationship and the communication protocol, are often fixed in the in-vehicle network. Thus, since it is easy to register the frame processing information as shown in FIG. 3 in advance, the configuration for performing frame relay control as described above in the in-vehicle network is particularly effective.

The in-vehicle relay device 101 is not limited to having an in-vehicle ECU 202 directly connected to itself, and it is also possible to perform various types of processing such as making the aforementioned determination after receiving frames transmitted via another in-vehicle relay device.

Further, the in-vehicle relay device 101 is not limited to the configuration of relaying frames transmitted and received between the in-vehicle ECUs 202 in a star topology with peer-to-peer communication like Ethernet. When an in-vehicle system 301 includes CAN (Controller Area Network) buses, it may be configured to relay frames between in-vehicle devices connected to different CAN buses, and may perform various types of processing such as making the aforementioned determination for the frames. However, the transmission of frames transmitted and received between the in-vehicle ECUs 202 can be easily restricted by the configuration in which the in-vehicle relay device 101 relays frames in a star topology with peer-to-peer communication, as described above.

Further, in the in-vehicle system according to the embodiment of the present disclosure, the in-vehicle relay device 101 is configured to use the processing load rate, but there is no limitation to this configuration. For example, the in-vehicle relay device 101 may be configured to perform frame relay control using a processing load amount and a processing load amount threshold.

Further, in the in-vehicle system according to the embodiment of the present disclosure, the in-vehicle relay device 101 is configured to use the frame processing information in which information for each in-vehicle ECU 202 and each type of frame has been registered, but there is no limitation to this configuration. The in-vehicle relay device 101 may be configured to use frame processing information in which information common to the in-vehicle ECUs 202 in the in-vehicle network 151 has been registered, may be configured to use frame processing information in which information common to the types of frames has been registered, or may be configured to use frame processing information in which information common to the in-vehicle ECUs 202 and the types of frames in the in-vehicle network 151 has been registered.

Further, in the in-vehicle system according to the embodiment of the present disclosure, the in-vehicle relay device 101 is configured to update the processing load rate based on the elapsed time from when the relay unit 22 receives or relays frames, but there is no limitation to this configuration. For example, the in-vehicle relay device 101 may be configured to restrict the number of frames registered for one in-vehicle ECU 202 to a predetermined value in the load information, and, when new frames are received and the number exceeds the predetermined value, the information of the oldest frames is deleted, and the corresponding load increase rate is subtracted from the processing load rate.

The aforementioned embodiments should be considered as illustrative in all respects and not restrictive. The scope of the present disclosure is indicated by the scope of the claims rather than the aforementioned description, and is intended to include all changes within the meaning and scope equivalent to the scope of the claims.

The aforementioned description includes the features appended below.

### Supplementary Note 1

An in-vehicle relay device includes a relay unit configured to relay frames transmitted and received between one in-vehicle device and another in-vehicle device in an in-vehicle network, a calculation unit configured to calculate a processing load of the other in-vehicle device based on a plurality of frames that were received from the one in-vehicle device by the relay unit and are addressed to the other in-vehicle device; and a determination unit configured to determine whether or not the relay unit is to relay the frames addressed to the other in-vehicle device based on the processing load calculated by the calculation unit, wherein the calculation unit calculates a sum of the processing loads respectively corresponding to the received frames as the processing load of the other in-vehicle device.

1. An in-vehicle relay device comprising:
a relay unit configured to relay frames transmitted and received between one in-vehicle device and another in-vehicle device in an in-vehicle network;
a calculation unit configured to calculate a processing load of the other in-vehicle device based on a plurality of frames that were received from the one in-vehicle device by the relay unit and are addressed to the other in-vehicle device; and
a determination unit configured to determine whether or not the relay unit is to relay the frames addressed to the other in-vehicle device based on the processing load calculated by the calculation unit.

2. The in-vehicle relay device according to claim 1, further including;
a storage unit configured to store frame processing information indicating a processing load of frames in each of the in-vehicle devices for each type of frame, wherein
the calculation unit calculates the processing load based on the type of each of the received frames and the frame processing information.

3. The in-vehicle relay device according to claim 2, wherein
the frame processing information further indicates a processing time required for each of the in-vehicle devices to process frames for each type of frame, and
the calculation unit updates the processing load based on an elapsed time from when the relay unit received or relayed the received frames and the processing time corresponding to the received frames.

4. The in-vehicle relay device according to claim 1, further including;
a storage unit configured to store frame processing information indicating, for each of the in-vehicle devices, a processing load of frames in the in-vehicle device, wherein
the calculation unit calculates the processing load based on the processing load corresponding to the other in-vehicle device in the frame processing information.

5. The in-vehicle relay device according to claim 4, wherein
the frame processing information further indicates, for each of the in-vehicle devices, a processing time required for the in-vehicle device to process frames, and
the calculation unit updates the processing load based on an elapsed time from when the relay unit received or relayed the received frames and the processing time corresponding to the received frames.

6. The in-vehicle relay device according to claim 1, further including;
a storage unit configured to store frame processing information indicating a threshold of the processing load for each of the in-vehicle devices, wherein
the determination unit makes the determination based on a comparison result of a comparison between the processing load calculated by the calculation unit and the threshold corresponding to the other in-vehicle device in the frame processing information.

7. The in-vehicle relay device according to claim 1, wherein
the determination unit makes the determination based on a comparison result of a comparison between the processing load calculated by the calculation unit and a threshold, and
the threshold is a value based on a result of measurement of a frame transmission cycle in a vehicle having a predetermined network configuration.

8. The in-vehicle relay device according to claim 1, wherein
the in-vehicle relay device relays the frames transmitted and received between the in-vehicle devices in a star topology with peer-to-peer communication.

9. A relay method in an in-vehicle relay device including a relay unit that relays frames transmitted and received between one in-vehicle device and another in-vehicle device in an in-vehicle network, the method comprising the steps of:
calculating a processing load of the other in-vehicle device based on a plurality of frames that were received from the one in-vehicle device by the relay unit and are addressed to the other in-vehicle device; and
determining whether or not the relay unit is to relay the frames addressed to the other in-vehicle device based on the calculated processing load.

10. A relay program to be used in an in-vehicle relay device and causing a computer to function as:
a relay unit configured to relay frames transmitted and received between one in-vehicle device and another in-vehicle device in an in-vehicle network;
a calculation unit configured to calculate a processing load of the other in-vehicle device based on a plurality of frames that were received from the one in-vehicle device by the relay unit and are addressed to the other in-vehicle device; and
a determination unit configured to determine whether or not the relay unit is to relay the frames addressed to the other in-vehicle device based on the processing load calculated by the calculation unit.
